(19) United States
(12) Patent Application Publication
(10) Pub. No.: US 2010/0070908 A1
(43) Pub. Date: Mar. 18, 2010

(54) SYSTEM AND METHOD FOR ACCEPTING OR REJECTING SUGGESTED TEXT CORRECTIONS

(75) Inventors: Robert F. Mori, Palo Alto, CA (US); Eric D. Bergman, Menlo Park, CA (US); Timothy M. Dunn, Vallecito, CA (US)

Correspondence Address: OSHA LIANG L.L.P./SUN, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/233,277

(22) Filed: Sep. 18, 2008

(51) Int. Cl. G06F 3/048

(52) U.S. Cl. 715/773; 715/764

(57) ABSTRACT

A method for accepting or rejecting suggested text corrections, involving receiving a first input from a keyboard associated with a computing device, wherein the first input corresponds to a composition of a message in a text input area on the computing device, displaying a first suggested text correction, in response to the first input, during the composition of the message, receiving a first keypress on the keyboard, wherein the first keypress corresponds to a rejection of the suggested text correction, when a rejection of the suggested text correction is desired, receiving a second keypress on the keyboard, wherein the first keypress corresponds to an acceptance of the suggested text correction, when an acceptance of the suggested text correction is desired, and automatically inserting a space in the message when one selected from a group consisting of the first keypress and the second keypress is received.

### BACKGROUND

Typically, small, hand-held computing devices that include text input methods, such as a virtual keyboard, include text prediction and correction functionality. For example, most personal digital assistants and mobile phones include text auto-completion and suggested text corrections when a text error is detected. Typically, when a text input error is detected, the suggested text correction appears as a “word bubble” physically near to the input text. A user may either select the suggested text correction in the word bubble or reject the suggested text correction and use the original text input using various methods for accepting or rejecting the suggested text correction.

Most recently, the Apple® iphone® provides for an interface in which the word bubble including the suggested text correction also includes an “x” symbol/icon within the word bubble (Apple and iphone are a registered trademarks of Apple, Inc., Cupertino, Calif.). To reject the suggested text correction, the user must press the “x” symbol/icon to dismiss the word bubble each time an undesired suggested text correction appears. Using this method, when the user is inputting text (typing) a word, the user typically anticipates or looks for a suggested text correction and dismisses the suggested text correction before continuing to input text.

### SUMMARY

In general, in one aspect, the invention relates to a method for accepting or rejecting suggested text corrections, comprising receiving a first input from a keyboard associated with a computing device, wherein the first input corresponds to a composition of a message in a text input area on the computing device, displaying a first suggested text correction, in response to the first input, during the composition of the message, receiving a first keypress on the keyboard, wherein the first keypress corresponds to a rejection of the suggested text correction, when a rejection of the suggested text correction is desired, receiving a second keypress on the keyboard, wherein the first keypress corresponds to an acceptance of the suggested text correction, when an acceptance of the suggested text correction is desired, and automatically inserting a space in the message when one selected from a group consisting of the first keypress and the second keypress is received.

In general, in one aspect, the invention relates to a user interface on a computing device for responding to suggested text corrections, comprising a text input area for composing a message using a virtual keyboard on the computing device, a suggested text correction area comprising a suggested text correction, wherein the suggested text correction is displayed during the composition of the message, and a rejection area for rejecting the suggested text correction, wherein the virtual keyboard comprises a spacebar, wherein the spacebar comprises a first portion for rejecting the suggested text correction and a second portion for accepting the suggested text correction, wherein the user interface is configured to reject the suggested text correction and insert a space in the message when an input of a keypress of the first portion of the spacebar is received, and wherein the user interface is configured to accept the suggested text correction and insert a space in the message when an input of a keypress of the second portion of the spacebar is received.

In general, in one aspect, the invention relates to a method for accepting or rejecting suggested text corrections, comprising receiving a first input from a virtual keyboard associated with a computing device, wherein the first input corresponds to a composition of a message in a text input area on the computing device, and wherein the text input area comprises a suggested text correction area and a rejection area, displaying a first suggested text correction in the suggested text correction area during the composition of the message, receiving a second input from a suggested text correction area comprising the suggested text correction, when an acceptance of the first suggested text correction is desired, wherein the second input from the suggested text correction area accepts the first suggested text correction without the insertion of space into the message, and receiving a third input from a rejection area, when a rejection of the first suggested text correction is desired, wherein the rejection area is an area that rejects a suggested text correction without the insertion of a space into the message. Other aspects of the invention will be apparent from the following description and the appended claims.

### BRIEF DESCRIPTION OF DRAWINGS

FIG. 1 shows a system in accordance with one or more embodiments of the invention.

FIGS. 2A-2B show a user interface in accordance with one or more embodiments of the invention.

FIGS. 3-4 show flow charts in accordance with one or more embodiments of the invention.

FIGS. 5A-5G show example user interfaces in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for accepting or rejecting suggested text corrections when typing a message on a computing device. More specifically, embodiments of the invention provide a system and method for accepting or declining suggested text corrections without breaking the flow of typing a message on a computing device. To facilitate the above, embodiments of the invention implement the acceptance or rejection of suggested text corrections on or around the spacebar key on a keyboard of the computing device.

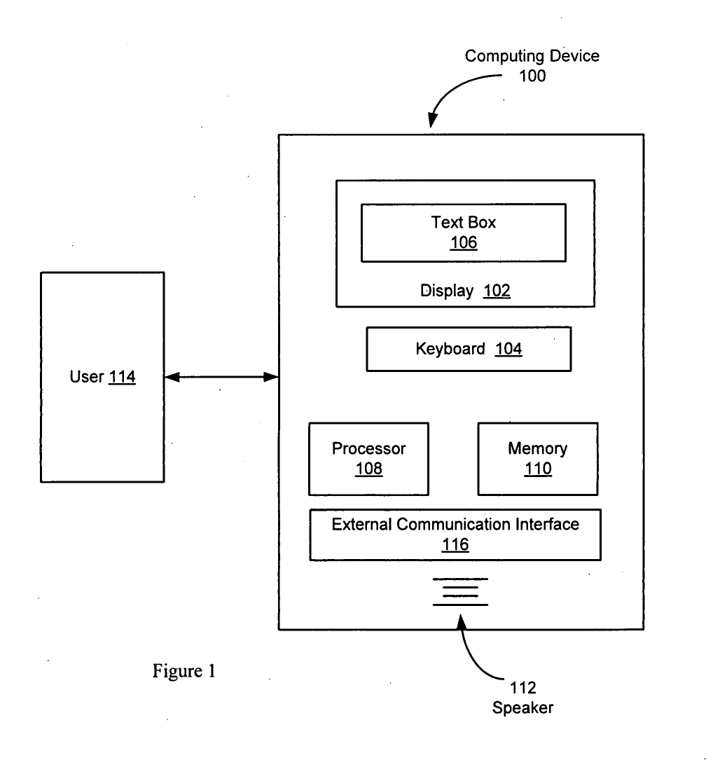

FIG. 1 shows a computing device in accordance with one or more embodiments of the invention. As shown in FIG. 1, the computing device (100) includes output means, such as a display (102), an input means e.g., a keyboard (104), a processor (108), associated memory (110), a sound engine (112), an external communication device (116), and numerous other elements and functionalities typical of today's computing devices (not shown). Those skilled in the art will appreciate that the input and output means may take other forms, now known (e.g., a virtual keyboard) or later developed. The computing device (100) may be a computer system, a laptop, a media device (i.e., a portable television or DVD player, etc), a gaming device, a mobile phone (including a smart phone), a personal digital assistant, or any other suitable wired or wireless computing device.

The display (102) may be a liquid crystal display (LCD) or any other type of suitable user interface. The display (102) includes a text box (106) for displaying text on the computing device. That is, the display (102) is an interface configured to display a text box (106). More specifically, the text box (106) is a text input area for composing messages on the computing device, such as electronic mail messages, short messaging service (SMS) messages or text messages, etc. Those skilled in the art will appreciate that the text box (106) may also be used to display text for a user of the computing device, such as notifications/alerts, a greeting message, the current date/time, etc.

Text is input into the computing device using a keyboard (104) associated with the computing device (104). The inputted text is subsequently displayed in the text box (106). The keyboard may be a wired keyboard, a wireless keyboard, a virtual keyboard, a keypad, or any other type of suitable input device that includes keys that are pressed to input data. The keyboard may be a full keyboard with all standard keys included, or may be a partially equipped keyboard that includes a subset of the keys typically included on a full keyboard. Further, the keyboard may be a QWERTY, English-based keyboard, a modified version of the QWERTY keyboard for international use (i.e., an English-international layout), or an extended keyboard with extended characters (i.e., an English-extended layout).

Those skilled in the art will appreciate that the invention may also be implemented with foreign-language keyboards.

The computing device includes a processor (108) for executing applications and software instructions configured to perform various functionalities, and memory (110) for storing software instructions and application data. Software instructions to perform embodiments of the invention may be stored on any tangible computer readable medium such as a compact disc (CD), a diskette, a tape, a memory stick such as a jump drive or a flash memory drive, or any other computer or machine readable storage device that can be read and executed by the processor (108) of the computing device. The memory (110) may be flash memory, a hard disk drive (HDD), persistent storage, random access memory (RAM), read-only memory (ROM), any other type of suitable storage space, or any combination thereof.

The external communication interface (116) may be an antenna, a serial port, a parallel port, a USB interface, or any type of network interface connection, such as Bluetooth® (Bluetooth is a registered trademark of Bluetooth SIG, Inc.), infrared signal, etc. Further, the external communication interface may also support Global System for Mobile (GSM) communications, and 3G and/or 4G standards for mobile phone communication. In one or more embodiments of the invention, the computing device (100) may be connected to a local area network (LAN) or a wide area network (e.g., the Internet) (not shown) via the external communication interface (116). Further, the external communication interface (116) may support both wired and wireless interfaces.

The computing device (100) is typically associated with a user (118) using the computing device (100). For example, the user may be an individual, a company, an organization, a group of individuals, or another computing device. In one or more embodiments of the invention, the user (118) is an individual consumer that uses the computing device (100) as a personal electronic device.

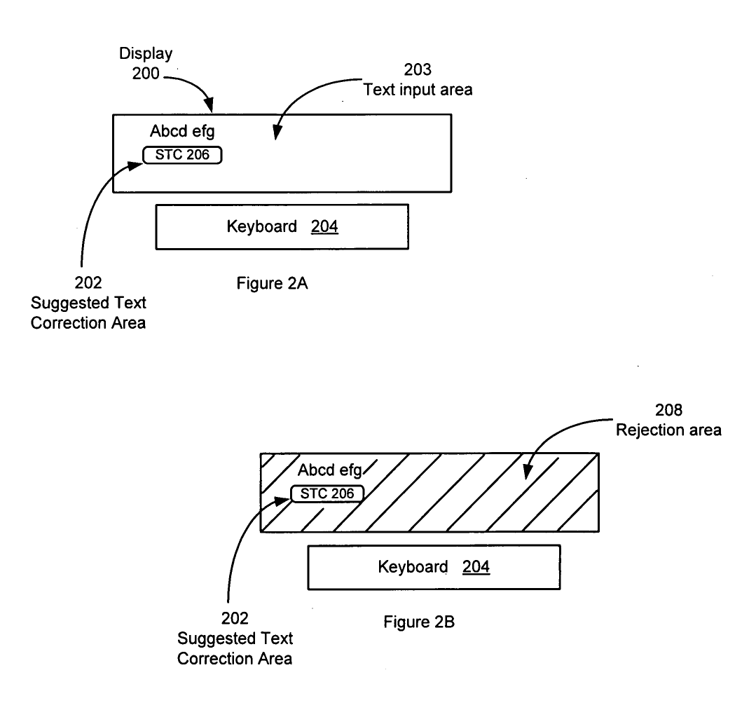

FIGS. 2A-2B show a user interface in accordance with one or more embodiments of the invention. More specifically, FIG. 2A shows a display (200) (i.e., output screen) associated with a computing device, and a keyboard (204). Those skilled in the art will appreciate that the display (200) of FIG. 2 may correspond to the display (102) shown in FIG. 1 or a portion of the display (102) of FIG. 1. Further, as described above, the keyboard (204) may be any type of keyboard, including a virtual keyboard, a wired or wireless full QWERTY keyboard, a partial keyboard, a foreign-language keyboard, etc. In embodiments of the invention implemented using a virtual keyboard, characters displayed on the virtual keyboard may be selected/typed using a stylus, a pen, a finger, or any other suitable item for selecting keys on a virtual keyboard.

The display shown in FIG. 2A includes a text input area (203) and a suggested text correction area (202). The text input area (203) is configured to display typed characters input from the keyboard (204). The suggested text correction area (202) is a portion of the display area that is used to display a suggested text correction (206). As is well known in the art, a suggested text correction is a word or phrase that the computing device suggests in place of or as a replacement for a typed word or phrase.

The suggested text correction area (202) is shown in FIG. 2A as a word bubble. However, those skilled in the art will appreciate that the suggested text correction may be displayed in or represented by any type of icon, and is not limited to a word bubble that includes the suggested text correction. The suggested text correction area (202) may be any area of space within the text input area that is displayed as an icon or symbol representing a suggested text correction (206). Further, although the suggested text correction area (202) is shown as including the suggested text correction (206), those skilled in the art will appreciate that the suggested text correction (206) may appear below, above, next to, or in any other suitable configuration to an area designated as the suggested text correction area. For example in one or more embodiments of the invention, when the keyboard (204) is a virtual keyboard, the suggested text correction area and suggested text correction may appear near the key that is designated as the key for responding to a suggested text correction (discussed below).

In one or more embodiments of the invention, the suggested text correction area (202) may include one or more symbols or icons for accepting and/or rejecting a suggested text correction (206). For example, the suggested text correction area (202) may include an “x” symbol, along with the suggested text correction, for rejecting the suggested text correction (206) that is displayed in the suggested text correction area (202). Alternatively, the suggested text correction area (202) may include a check mark next to the suggested text correction, indicating that a selection of the check mark would accept the suggested text correction (206). In one or more embodiments of the invention, the suggested text correction area (202) may include more than one symbol/icon for both accepting and rejecting suggested text corrections. Those skilled in the art will appreciate that the symbol/icon representing an acceptance and rejection of a suggested text correction may be any visual representation that may be displayed within the suggested text correction area (202). For example, the suggested text correction area (202) may include an “a” and/or an “r” for accepting and rejecting suggested text corrections, respectively.

FIG. 2B shows the same components discussed above with respect to FIG. 2A, and in addition, includes a rejection area (208). The rejection area (208) includes the area within the text input area (203) and outside of the suggested text correction area (202). In one or more embodiments of the invention, the rejection area (208) is used to reject a suggested text correction (206). More specifically, a selection or input made within the rejection area (208) while a suggested text correction is displayed by the computing device results in a rejection of the suggested text correction. An input within the rejection area (208) may be made with a stylus (in the case of a virtual keyboard), by any keypress on the keyboard, a mouse click or drag, a roller-ball movement, a scroll, or any suitable method for selecting or inputting within the rejection area (208).

In one or more embodiments of the invention, with respect to both FIGS. 2A and 2B, the keyboard (204) includes at least one key that is designated as a key corresponding to an acceptance and/or a rejection of a displayed suggested text correction. That is, the keyboard (204) includes at least one key that is used to respond to suggested text corrections displayed by the computing device during the composition of a message. In one or more embodiments of the invention, the key used to respond to suggested text corrections is the spacebar. Specifically, in one embodiment of the invention, the right side of the spacebar corresponds to an acceptance of a suggested text correction, and the left side of the spacebar corresponds to a rejection of a suggested text correction.

Those skilled in the art will appreciate that although the remainder of the discussion below focuses on the spacebar as the designated key for responding to suggested text corrections, embodiments of the invention are not limited to the examples used in the discussion below. Rather, any key on a keyboard associated with a computing device may be designated as the key used for responding to suggested text corrections. For example, embodiments of the invention may be designate the enter key, the delete key, the backspace key, the tab key, the shift key, or any other suitable key as the key for responding to suggested text corrections. Further, embodiments of the invention may be implemented with more than one key used to respond to suggested text corrections. For example, the enter key may be used to accept a suggested text correction, and the delete or backspace key (or both) may be used to reject a suggested text correction. Alternatively, the invention may use the layout of a standard QWERTY keyboard to designate the right shift key as the key for accepting suggested text corrections and the left shift key as the key for rejecting suggested text corrections.

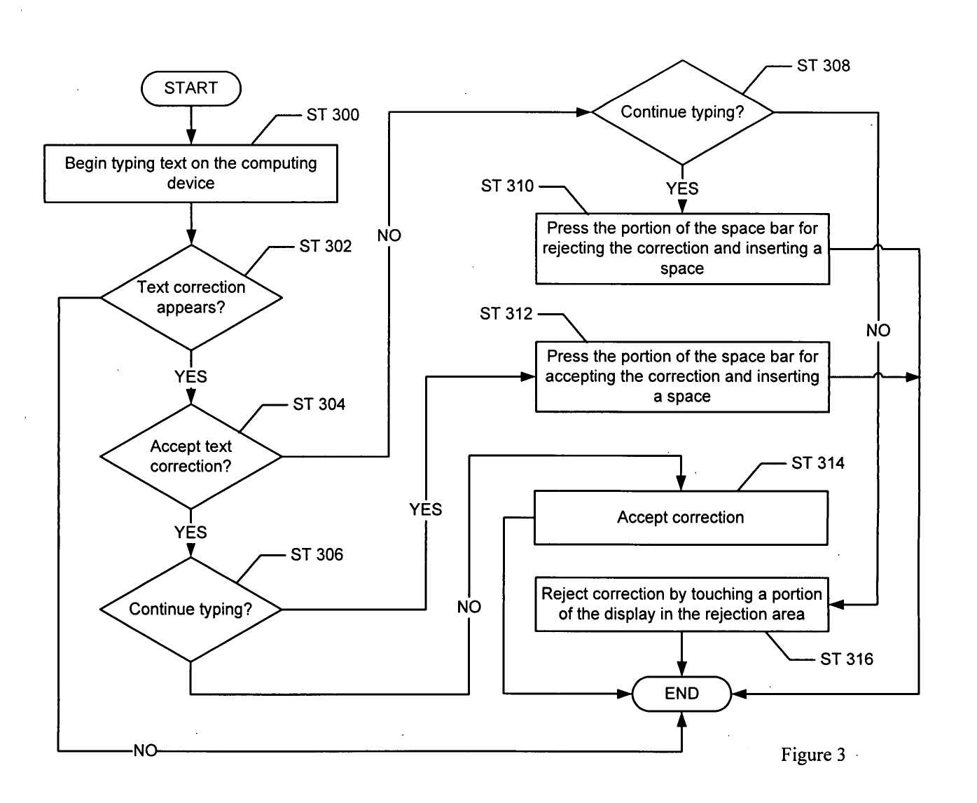

FIG. 3 shows a flow chart for accepting or rejecting suggested text corrections in accordance with one or more embodiments of the invention. In one or more embodiments of the invention, one or more of the steps described below may be omitted, repeated, and/or performed in a different order. Accordingly, the specific arrangement of steps shown in FIG. 3 should not be construed as limiting the scope of the invention.

Initially, a user begins inputting text on the computing device (ST 300). In one or more embodiments of the invention, the text is part of a message composed using the computing device. The message may be in the form of an e-mail, a text message, any other suitable type of message, now known or later developed, or any combination thereof. Subsequently, the user determines whether a suggested text correction appears (ST 302). That is, the user may visually identify a suggested text correction that is displayed by the computing device during the composition of the user's message. Alternatively, in one or more embodiments of the invention, a suggested text correction may be displayed without the user visually identifying the suggested text correction. Said another way, a suggested text correction may be displayed by the computing device without any notice to the user. Those skilled in the art will appreciate that a suggested text correction in the context of embodiments of the invention appears at the end of a word or phrase typed by the user. Further, a suggested text correction that appears in the midst of a word or phrase being typed may be ignored by the user by simply continuing to input characters. Whether the user knows that the system has displayed suggested text correction or not, if a suggested text correction appears during the composition of the message, then a second determination is made as to whether the user wishes to accept the suggested text correction (ST 304). Those skilled in the art will appreciate that when a suggested text correction is not displayed by the system during the entirety of the composition of the message, the process ends.

Continuing with FIG. 3, when the user wishes to accept the suggested text correction, a determination is made as to whether the user wishes to continue typing (i.e., inputting characters) on the computing device (ST 306). More specifically, ST 306 refers to whether the user wishes to type a new word (or character) that is separated by a space from the previous word e.g., adding a space and then an exclamation mark). In one or more embodiments of the invention, when the user wishes to both accept the suggested text correction and continue inputting text for a new word (or new character) the user presses the portion of the spacebar on the keyboard of the computing device that corresponds to an acceptance of a suggested text correction (ST 308). In this case, when the wishes wish to both accept the suggested text correction and continue typing, the suggested text correction is accepted and a space is inserted as the next character in the message by pressing the portion of the spacebar that corresponds to accepting the suggested text correction (ST 312). Alternatively, in one or more embodiments of the invention, if the user wishes to accept the suggested text correction and end the message (ST 306) (i.e., no further characters are to be typed in the message), then the user may accept the suggested text correction without the insertion of a space in the message (ST 314). Accepting the suggested text correction may involve selecting the word bubble including the suggested text correction, pressing any key on the keyboard of the computing device, any other suitable action that may be performed using the keyboard or other input device associated with the computing device, or any combination thereof.

Those skilled in the art will appreciate that when the user wishes to input additional characters that are not for a new word, such as a punctuation mark, the user may not need to insert a space along with the acceptance or rejection of the suggested text correction. In this case, the user may accept/reject the suggested text correction by making a selection in the suggested text correction area or the rejection area, respectively.

At ST 304, in one or more embodiments of the invention, when the user wishes to reject the suggested text correction, the determination as to whether the user wishes to continue typing the message is made again (ST 308). If the user wishes to reject the suggested text correction and continue typing the message, then the user presses the portion of the spacebar that corresponds to a rejection of the suggested text correction (ST 310). In this case, in one or more embodiments of the invention, by pressing the portion of the spacebar that corresponds to a rejection of the suggested text correction, the computing device automatically inserts a space into the message, such that the space character facilitates the continuation of the message composition. Alternatively, when the user wishes to reject the suggested text correction and end the message, the user may reject the suggested text correction by selecting in the rejection area within the text input area (ST 316). As described above, the rejection area includes any portion of the display screen on the computing device that is outside the suggested text correction area and within the text input area. In one or more embodiments of the invention, the rejection area may also include the portion of the text input area that includes previously typed text.

Thus, using embodiments of the invention described above, the user has several options for responding to a suggested text correction. The user may accept a suggested text correction and insert a space to continue the flow of composing the message, accept a suggested text correction and end the message, reject a suggested text correction and insert a space, or reject a suggested text correction and end the message. Those skilled in the art will appreciate that the aforementioned steps of FIG. 3 may be repeated for each suggested text correction that appears during the composition of any type of message on the computing device.

Further, in one or more embodiments of the invention, the method shown in FIG. 3 facilitates responding to suggested text corrections without disrupting the flow of composing a message on a computing device. More specifically, a user using a computing device does not have to visually identify a suggested text correction that appears during the composition of the message. In addition, a user also is not required to visually identify that a response to the suggested text correction was made. Rather, by associating an acceptance and rejection of a suggested text correction with a common key on a keyboard that is used during the composition of a message, such as the spacebar, a user can respond to a suggested text correction by pressing the appropriate key (or portion of a key).

For example, suppose the computing device is set up with the spacebar as the key for responding to suggested text corrections, where the right side of the spacebar corresponds to a rejection and the left side of the spacebar corresponds to an acceptance of the suggested text correction. Those skilled in the art will appreciate the left side of the spacebar may correspond to an acceptance, and the right side of the spacebar may correspond to a rejection of a suggested text correction. Suppose further that the user inputs characters for a word or phrase that the user knows will trigger a suggested text correction, such as a name of a person or place, an abbreviation used in colloquial language, etc. When the user has completed the word or phrase, the user can simply press the right side of the spacebar, without visually acknowledging the suggested text correction, and the user is assured that the suggested text correction will disappear and a space will automatically be inserted into the message. This allows the user to continue typing the message without breaking the flow of typing to reject the suggested text correction. Similarly, the user can accept the suggested text correction and continue typing the message by pressing the left side of the spacebar. Over time, when the user becomes accustomed to the key or key(s) that the computing device is configured to associate with the acceptance or rejection of suggested text corrections, the user can efficiently and quickly respond to suggested text corrections in a natural manner, without any visual confirmation of the actions that took place in response to suggested text corrections.

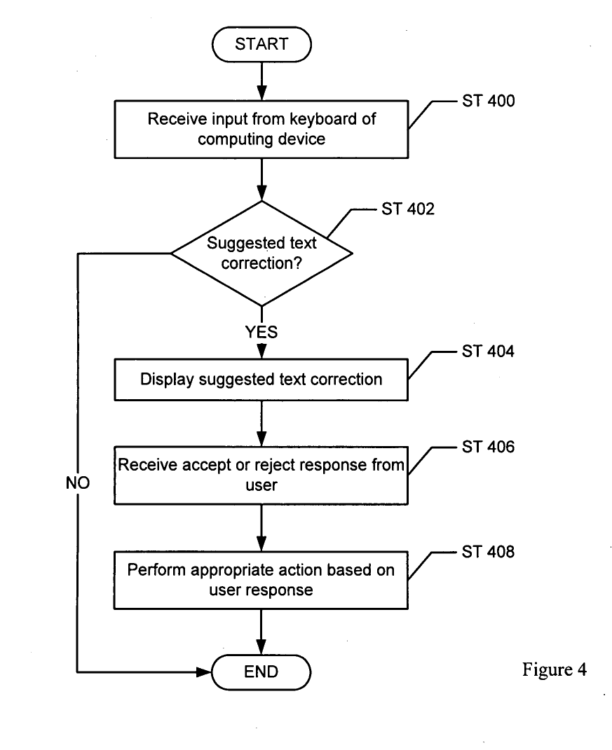

FIG. 4 shows a flow chart for In one or more embodiments of the invention, one or more of the steps described below may be omitted, repeated, and/or performed in a different order. Accordingly, the specific arrangement of steps shown in FIG. 4 should not be construed as limiting the scope of the invention.

Initially, the computing device receives input from a keyboard associated with the computing device (ST 400). The input received is subsequently displayed in a text input area on a display of the computing device (not shown). Next, a determination is made as to whether a suggested text correction is displayed (ST 402). If the system determines that a suggested text correction is not required for the input received from the keyboard, then the process ends.

Alternatively, when the system determines that a suggested text correction is needed during the composition of the user's message, the suggested text correction is displayed onto the display of the computing device (ST 404). As described above, the suggested text correction may be displayed in a word bubble (or other type of icon representing/including the suggested text correction) next to or physically near the displayed text that the user's inputs. Alternatively, in the case where the user is using a virtual keyboard on the computing device, the word bubble may be displayed in physical proximity to the key on the keyboard designated as the suggested text correction response key (e.g., the spacebar, the enter key, etc). The system then receives the user's response to the displayed suggested text correction (ST 406). More specifically, the user's response may be an acceptance or a rejection of the suggested text correction. In one or more embodiments of the invention, the response received by the computing device may be in the form of a keypress that corresponds to an acceptance of the suggested text correction, a keypress that corresponds to a rejection of the suggested text correction, a selection within the rejection area for rejecting the suggested text correction, or a selection of the displayed word bubble that includes the suggested text correction, signaling an acceptance of the suggested text correction.

Upon receiving a response to the suggested text correction, the computing device performs the appropriate action in response to the user's input (ST 408). That is, the computing device may perform one of several actions corresponding to the various options for responding to the suggested text correction by the user. For example, when the user's response to the suggested text correction is a keypress of the key (or portion of the key) corresponding to an acceptance of the suggested text correction, the system inserts the suggested text correction in place of the typed input and inserts a space into the message being composed on the computing device. Alternatively, when the user's response to the suggested text correction is a keypress of the key (or portion of the key) corresponding to a rejection of the suggested text correction, the system removes the word bubble (or other displayed icon representing/including the suggested text correction) including the suggested text correction from the display and inserts a space into the message. When the user makes a selection in the rejection area of the text input area on the display of the computing device, the system responds by only removing the word bubble including the suggested text correction from the display. Alternatively, when the user selects the word bubble including the suggested text correction, the system responds by only inserting the suggested text correction in place of the inputted text on the display. Those skilled in the art will appreciate that the aforementioned steps of FIG. 4 may be repeated each time the system displays a suggested text correction to which the user responds during the composition of any type of message on the computing device.

Although not shown or discussed in FIG. 4, in one or more embodiments of the invention, the computing device may be configured to play one or more unique sounds to indicate to a user using the computing device to compose a message whether a suggested text correction has been accepted or rejected. The one or more unique sounds are output through the speaker of the computing device. For example, in one or more embodiments of the invention, the computing device may be configured to output a first unique sound for an acceptance of a suggested text correction and a second unique sound for a rejection of a suggested text correction. Alternatively, in one or more embodiments of the invention, the computing device may be configured to output a unique sound for each type of response that may be received from a user. More specifically, each of the options for responding to a suggested text correction may be associated with a unique sound that is output by the computing device. By outputting a unique sound for an acceptance and a rejection of a suggested text correction, a user using a computing device may be made aware of an action that the user has taken without visually identifying or responding to a suggested text correction.

For example, suppose a user using a computing device inputs characters using a keyboard, in response to which the computing device displays a suggested text correction. Because embodiments of the invention facilitate the acceptance and rejection of suggested text corrections by pressing a key that a user may normally press during the natural flow of the composition of a message (e.g., the spacebar, the return key, etc.), the user may accept or reject a suggested text correction without being aware that a text correction was suggested by the computing device. In this case, a unique sound played by the computing device would indicate to the user that a suggested text correction was either accepted or rejected immediately after the action of accepting or rejecting the suggested text correction occurs. Those skilled in the art will appreciate that the computing device may associate only one unique sound to both the acceptance and the rejection of a suggested text correction. Further, those skilled in the art will appreciate that the sound associated with an acceptance or rejection of a suggested text correction may be distinct from other sounds that may be played back by the computing device, e.g., a sound associated with any keypress or a keypress of a particular key, a sound associated with deleting an item on the computing device, a sound associated with performing an illegal action on the computing device, etc.

Those skilled in the art will appreciate that, although not shown in the computing device of FIG. 1, a computing device that includes functionality to play unique sounds for responses to suggested text corrections may include a sound engine or sound generating module configured to associate a sound with particular actions and determine which sound should be output when the particular action occurs. Further, to map sounds to various actions, the memory of the computing device may include a look-up table or other data structure to store the association of one or more sounds to particular actions.

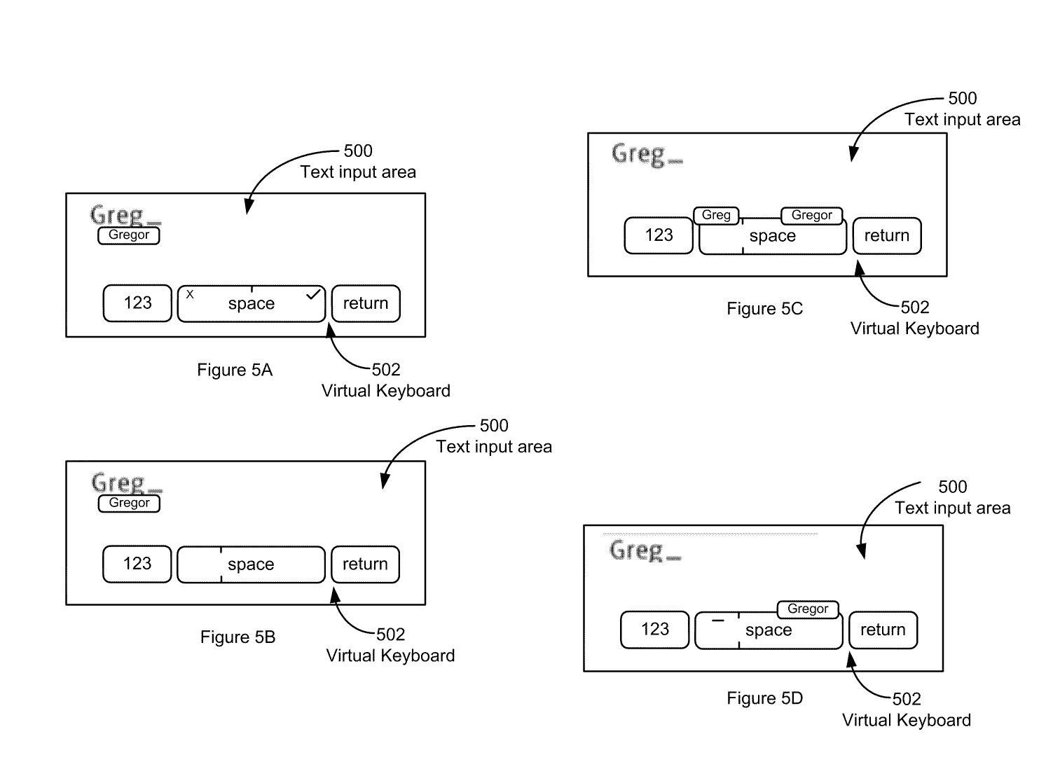

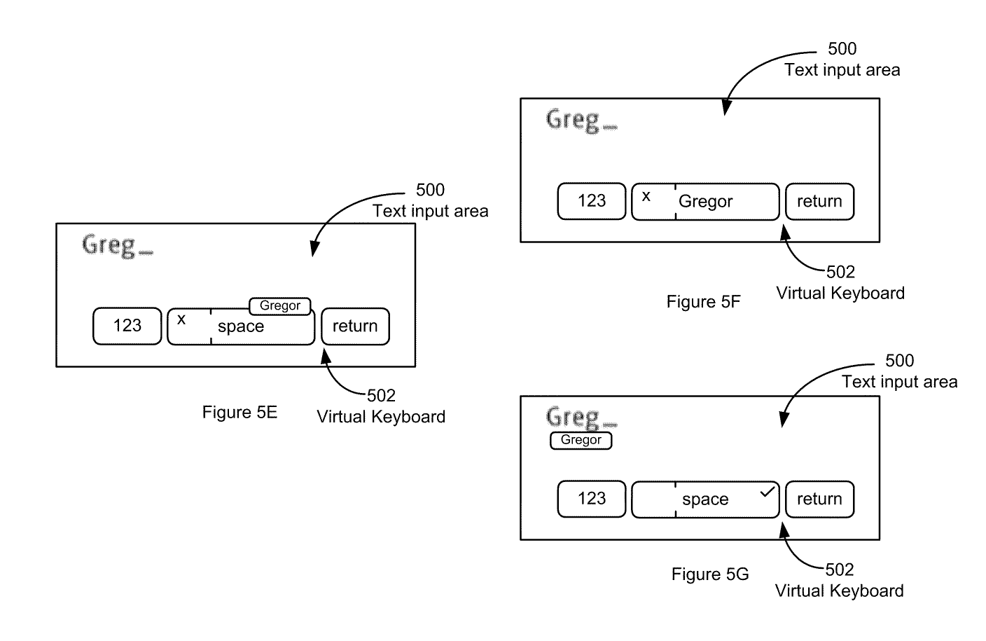

FIGS. 5A-5G show examples of user interfaces for responding to suggested text corrections in accordance with one or more embodiments of the invention. Those skilled in the art will appreciate that although the invention may be performed using any type of computing device and keyboard combination, the examples shown in FIGS. 5A-5G are discussed with reference to a virtual keyboard that is displayed on the computing device's display screen. The following examples are not intended to limit the scope of the invention.

The user interfaces of FIG. 5A-5G show a text input area (500) and a portion of a virtual keyboard (502). The portion of the virtual keyboard (502) shown in FIGS. 5A-5G show a spacebar, a return key (enter key), and a number key. In the examples described below with respect to FIGS. 5A-5G, the spacebar is the key that is used to respond to suggested text corrections. Further, in the following examples, the user is typing the proper noun (name) “Greg”, and the suggested text correction displayed by the computing device is “Gregor.” More specifically, the suggested text correction area (shown as a word bubble in FIGS. 5A-5B) includes the suggested text correction “Gregor.”

As described above, embodiments of the invention provide the user with several options for responding to a suggested text correction. Specifically, the user may accept the suggested text correction and continue inputting text with the automatic insertion of a space, reject the suggested text correction and continue inputting text with the automatic insertion of a space, accept the suggested text correction and end the message (or type a character that does not require the insertion of a space first), or reject the suggested text correction and end the message (or type a character that does not require the insertion of a space first).

Beginning with FIG. 5A, the user types the characters “Greg” and the computing device displays a suggested text correction word bubble including the text characters “Gregor.” If the user wishes to accept the suggested text correction, thereby replacing “Greg” with “Gregor,” and continue inputting text or typing a message, then the user presses the right portion of the spacebar, as indicated by the check mark displayed on the upper right-hand corner of the spacebar. Alternatively, if the user wishes to reject the suggested text correction and keep the text “Greg,” and continue inputting characters after the automatic insertion of a space, then the user presses the left portion of the spacebar, as indicated by the “x” mark displayed on the upper left-hand corner of the spacebar. Alternatively, to accept the suggested text correction and end the message (or ignore the automatic insertion of a space into the message for any other reason) the user may select (e.g., click on) the word bubble including the suggested text correction “Gregor.” That is, the suggested text correction word bubble is the suggested text correction acceptance area. Similarly, to reject the suggested text correction and end the message (or avoid the insertion of a space), the user may select, type, or move an input device, such as a mouse, anywhere in the rejection area. In one or more embodiments of the invention, the rejection area includes any portion of the text input area, except the suggested text correction word bubble. In one or more embodiments of the invention, the rejection area also includes any key on the virtual keyboard, except the spacebar and the punctuation keys, because the input of any character after the appearance of a suggested text correction ignores the suggested text correction. Those skilled in the art will appreciate that the input of a punctuation key accepts a suggested text correction without the insertion of a space.

In one or more embodiments of the invention, the check and “x” marks displayed on the respective portions of the spacebar are acceptance and rejection indicators that are displayed on the key used to respond to suggested text corrections. The acceptance and rejection indicators may be any graphical image, icon/symbol, text, or any combination thereof. For example, a blank rectangle in the spacebar may be used to represent a rejection of the suggested text correction. In this case, the blank rectangle represents ignoring the suggested text correction and inserting a space into the message being composed on the computing device. Further, the acceptance and rejection indicators may be displayed on the key used to respond to suggested text corrections, as shown in FIG. 5A, or above, below, next to, or in physical proximity to the key used to respond to suggested text corrections. Alternatively, or in addition to the indicators on the key, the acceptance and rejection indicators may be displayed within the rejection area and the suggested text correction area within the text input area of the display.

Further, in one or more embodiments of the invention, acceptance and/or rejection indicators may be denoted on a virtual keyboard by different colors or different shades of the same color on various portions of the spacebar. For example, one portion of the spacebar in a virtual keyboard may include a first shade of a color indicating a rejection of a suggested text correction and the insertion of a space and another portion of the spacebar may include a second shade of the color indicating an acceptance of a suggested text correction and the insertion of a space. In one embodiment of the invention, the portion of the spacebar indicating a suggested text correction and the insertion of a space and/or the portion of the spacebar indicating a rejection of a suggested text correction and the insertion of a space may be identified with a combination of color, graphical images, icons, symbols, and/or text.

In one or more embodiments of the invention, the acceptance and rejection indicators may appear when a suggested text correction appears on the display, and subsequently disappear upon responding to the suggested text correction. Alternatively, the acceptance and rejection indicators may remain displayed in the respective acceptance/rejection keys or areas for the duration of the message composition. Further, the computing device may only display one of the acceptance and rejection indicators. Alternatively, in one or more embodiments of the invention, the computing device may not display indicators for accepting and rejecting suggested text corrections, as shown in the embodiment of FIG. 5B.

In the embodiment of FIG. 5C, the suggested text correction and the original inputted characters are both shown in word bubbles above the spacebar.

Said another way, the acceptance indicator is shown as the suggested text correction, and the rejection indicator is shown as the originally input text. Thus, the indicators are not symbols or icons, but the text that will result from an acceptance or a rejection of the suggested text correction. In FIG. 5D, the computing device displays a rejection indicator icon (i.e., a dash). More specifically, the acceptance indicator is represented by the suggested text correction. Similarly, in FIG. 5E, the rejection indicator is represented as an “x” while the acceptance indicator is the suggested text correction word bubble.

FIG. 5F shows an embodiment in which the acceptance indicator, represented by the suggested text correction, is displayed in the center of the spacebar, while the rejection indicator is an “x” on the upper left-hand corner of the spacebar. In this embodiment, the user has only three choices for responding to the suggested text correction. The user may reject the suggested text correction and insert a space into the message by pressing the left portion of the spacebar, reject the suggested text correction and end the message or avoid the insertion of a space by selecting anywhere in the rejection area, or accept the suggested text correction and insert a space into the message by pressing the right portion of the spacebar. The option for accepting the suggested text correction and ending the message or avoiding the insertion for a space is excluded from the embodiment shown in FIG. 5F.

In FIG. 5G, only an acceptance indicator icon (i.e., the check mark) is displayed by the computing device. Thus, all options for responding to the suggested text correction are available to the user, but a rejection indicator icon is omitted from being displayed on the virtual keyboard.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for accepting or rejecting suggested text corrections, comprising:
receiving a first input from a keyboard associated with a computing device, wherein the first input corresponds to a composition of a message in a text input area on the computing device;
displaying a first suggested text correction, in response to the first input, during the composition of the message;
receiving a first keypress on the keyboard, wherein the first keypress corresponds to a rejection of the suggested text correction, when a rejection of the suggested text correction is desired;
receiving a second keypress on the keyboard, wherein the first keypress corresponds to an acceptance of the suggested text correction, when an acceptance of the suggested text correction is desired; and
automatically inserting a space in the message when one selected from a group consisting of the first keypress and the second keypress is received.

2. The method of claim 1, further comprising:
displaying a rejection indicator on the first portion of the spacebar; and
displaying an acceptance indicator on the second portion of the spacebar,
wherein the rejection and the acceptance indicators are displayed after displaying the first suggested text correction.

3. The method of claim 2, wherein the rejection indicator and the acceptance indicator are removed after the first suggested text correction is one selected from a group consisting of the first keypress and the second key press, and reappear after a second suggested text correction is displayed.

4. The method of claim 2, wherein the rejection indicator is represented by a first shade of a color on the first portion of the spacebar, and wherein the acceptance indicator is represented by a second shade of the color on the second portion of the spacebar.

5. The method of claim 2, wherein the rejection indicator displays the first input, and the acceptance indicator is the first suggested text correction.

6. The method of claim 1, wherein the text input area comprises a suggested text correction area and a rejection area.

7. The method of claim 6, further comprising:
receiving a second input from the keyboard;
displaying a second suggested text correction, in response to the second input, during the composition of the message;
receiving a third input from the suggested text correction area, wherein the third input from the suggested text correction area accepts the second suggested text correction without the insertion of space into the message, when an acceptance of the second suggested text correction is desired; and
receiving a fourth input from the rejection area, wherein the rejection area is an area that rejects the suggested text correction without the insertion of a space into the message, when a rejection of the second suggested text correction is desired.

8. The method of claim 6, wherein the suggested text correction area comprises the suggested text correction.

9. The method of claim 1, wherein the first keypress corresponds to a first portion of the spacebar and the second keypress corresponds to a second portion of the spacebar.

10. The method of claim 1, wherein the keyboard is a virtual keyboard, and wherein the computing device is one selected from the group consisting of a personal digital assistant, a media device, and a mobile phone.

11. A user interface on a computing device for responding to suggested text corrections, comprising:
a text input area for composing a message using a virtual keyboard on the computing device;
a suggested text correction area comprising a suggested text correction, wherein the suggested text correction is displayed during the composition of the message; and
a rejection area for rejecting the suggested text correction,
wherein the virtual keyboard comprises a spacebar, wherein the spacebar comprises a first portion for rejecting the suggested text correction and a second portion for accepting the suggested text correction,
wherein the user interface is configured to reject the suggested text correction and insert a space in the message when an input of a keypress of the first portion of the spacebar is received, and
wherein the user interface is configured to accept the suggested text correction and insert a space in the message when an input of a keypress of the second portion of the spacebar is received.

12. The user interface of claim 11, further comprising:
a rejection indicator displayed on the first portion of the spacebar; and
an acceptance indicator displayed on the second portion of the spacebar,
wherein the rejection and the acceptance indicators are displayed after displaying the suggested text correction.

13. The user interface of claim 11, wherein the text input area comprises the suggested text correction area and the rejection area.

14. The user interface of claim 11, wherein the user interface is configured to reject the suggested text correction without the insertion of a space in the message when an input from the rejection area is received.

15. The user interface of claim 11, wherein the user interface is configured to accept the suggested text correction without the insertion of a space in the message when an input from the suggested text correction area is received.

16. A method for accepting or rejecting suggested text corrections, comprising:
receiving a first input from a virtual keyboard associated with a computing device, wherein the first input corresponds to a composition of a message in a text input area on the computing device, and wherein the text input area comprises a suggested text correction area and a rejection area;
displaying a first suggested text correction in the suggested text correction area during the composition of the message;
receiving a second input from a suggested text correction area comprising the suggested text correction, when an acceptance of the first suggested text correction is desired, wherein the second input from the suggested text correction area accepts the first suggested text correction without the insertion of space into the message; and
receiving a third input from a rejection area, when a rejection of the first suggested text correction is desired, wherein the rejection area is an area in which a selection rejects a suggested text correction without the insertion of a space into the message.

17. The method of claim 16, further comprising:
displaying a rejection indicator on a key corresponding to the first keypress; and
displaying an acceptance indicator on a key corresponding to the second keypress,
wherein the rejection and acceptance indicators are displayed after displaying the first suggested text correction.

18. The method of claim 17, wherein the rejection indicator and the acceptance indicator disappear after the first suggested text correction is one of accepted and rejected, and reappear after a second suggested text correction is displayed.

19. The method of claim 16, further comprising:
receiving a fourth input from the virtual keyboard;
displaying a second suggested text correction, in response to the fourth input, in the suggested text correction area during the composition of the message;
receiving a first keypress corresponding to a rejection of the second suggested text correction, when a rejection of the first suggested text correction is desired;
receiving a second keypress corresponding to an acceptance of the second suggested text correction, when an acceptance of the second suggested text correction is desired; and
automatically inserting a space in the message when one selected from a group consisting of the first keypress and the second keypress is received.

20. The method of claim 19, wherein the first keypress corresponds to a keypress of a first portion of a spacebar on the virtual keyboard, and wherein the second keypress corresponds to a keypress of a second portion of the spacebar on the virtual keyboard.
